(19) United States
(12) Patent Application Publication
(10) Pub. No.: US 2009/0065329 A1
(43) Pub. Date: Mar. 12, 2009

(54) WORKPIECE HOLDER

(75) Inventors: Paul Skljarow, Schwieberdingen (DE); Peter Ludwig, Tuebingen (DE); Uwe Lindemann, Holzgerlingen (DE); Volker Porzer, Baltmannsweiler (DE); Boris Buesing, Stuttgart (DE)

Correspondence Address: MICHAEL J. STRIKER, 103 EAST NECK ROAD, HUNTINGTON, NY, 11743, US

(73) Assignee: ROBERT BOSCH GMBH, Stuttgart (DE)

(21) Appl. No.: 12/160,164

(22) PCT Filed: Dec. 20, 2006
(86) PCT No.: PCT/DE2006/002285

§ 371 Date: Jul. 7, 2008

(30) Foreign Application Priority Data
Jan. 16, 2006 (DE) 10 2006 002 081.2

(51) Int. Cl. B65G 37/00

(52) U.S. Cl. 198/346.3

(57) ABSTRACT

A workpiece holder (56) for transporting workpieces in flexible processing lines, in particular assembly lines, is embodied for guidance along a guidance direction by means of a guide geometry of the processing line extending in the guidance direction, and the workpiece holder (56) has a first guide device (88, 88a, 88b) for guide engagement with the first guide geometry, and the workpiece holder (56) has a second guide device (90a), embodied separately from the first guide device, which second guide device is embodied for guide engagement with a second guide geometry, different from the first guide geometry.

The present invention relates to a workpiece holder for transporting workpieces in flexible processing lines, in particular assembly lines, which is embodied for guidance along a guidance direction by means of a guide geometry of the processing line extending in the guidance direction, and the workpiece holder has a first guide device for guide engagement with a first guide geometry extending in the guidance direction.

Such workpiece holders are known from the prior art for transporting workpieces in processing systems, such as small-part assemblies and the like. As a rule, a workpiece holder is associated to a kind of transporting device to whose guide geometry it is adapted.

A disadvantage of the known workpiece holders is the lack of flexibility, so that identical workpiece holders can be used as a rule only on identical transporting devices or with the same guide geometry.

It is therefore the object of the present invention to disclose a workpiece holder of the type defined at the outset that can be used on two different transporting devices.

This object is attained according to the invention by a workpiece holder of this generic type, in which the workpiece holder has a second guide device, embodied separately from the first guide device, which second guide device is embodied for guide engagement with a second guide geometry, different from the first guide geometry and extending in the guidance direction.

Thus the workpiece holder can be guided safely and securely and correctly in the same guidance direction on both the first and the second guide geometry, which can be associated with different transporting devices, so that the workpiece holder of the invention can be used within a wider range than conventionally known workpiece holders.

The word “guidance” in the sense of the present invention means the guidance of a motion of the workpiece holder along the course of an unbranched transportation path.

In principle, the guide device can be an arbitrary type of guide device. Advantageously, for especially simple embodiment of the guide device, the workpiece holder is embodied such that at least one guide device, and advantageously the first and the second guide devices, respectively, have a support face extending in the guidance direction, which face is associated with a guide geometry and embodied for sliding contact with a counterpart support face thereof. The guidance of the workpiece holder is then effected essentially by sliding contact of the support face and counterpart support face on one another. In the simplest case, the support face can be flat, but it can also have an arbitrary cross-sectional contour in a cross-sectional contour orthogonal to the guidance direction.

In principle, it can suffice for the workpiece holder to have only one support face per guide device. Especially secure guidance of the workpiece holder, however, is possible by providing that the at least one guide device, and advantageously both guide devices, have two support faces extending essentially in opposite directions in the guidance direction, of which each support face is embodied for sliding contact with a respective counterpart support face of a guide geometry. Faces in the sense of the present invention should be considered as pointing in the opposite direction when of their normal vectors, vector components extend in opposite directions. The normal vectors of each face should for that purpose be broken apart into linearly independent vector components of the same coordinate system.

In the aforementioned case of two support faces pointing in opposite directions, the spacing of the support faces orthogonally to the guide device from one another forms a lane width, so that the first guide device has a first guide lane width, and the second guide device has a second guide lane width that is different from the first guide lane width. With support faces pointing in opposite directions that form an angle with one another, the spacing between the centers of gravity of the faces of the respective support faces pointing in opposite directions should be used for determining a lane width.

Especially favorable guidance, because it is form-locking, of the workpiece holder can be obtained by providing that at least one guide device from the group comprising the first and second guide devices has at least one guide groove extending in the guidance direction, or has at least one guide rail extending in the guidance direction.

The aforementioned support face can be embodied, in a way that is especially simple and economical to produce, on an outer peripheral portion of the workpiece holder.

So that the workpiece holder can be guided in two guidance directions orthogonal to one another, or in other words can be transported by two transporting devices located orthogonally to one another, it can be embodied such that it has support faces and/or guide grooves and/or guide rails, in each case orthogonal to one another, and preferably pairs of support faces and/or pairs of guide grooves and/or pairs of guide rails that are all orthogonal to one another.

The aforementioned embodiments of the guide devices can also be combined with one another, so that for instance one guide device can have a guide groove or a guide rail, and the other guide device can have an outer peripheral portion, embodied as a support face, of the workpiece holder, as a result of which a compact workpiece holder with a small structural volume can be obtained.

The various transporting devices that transport the individual workpiece holders in the processing line can differ not only in the existing guide geometries but also in the conveyor means employed. For instance, transporting devices can have conveyor belts, but in different transporting devices these are located differently relative to the guide geometries. So that a workpiece holder can also be conveyed by differently designed conveyor means of different transporting devices, it is advantageous if it has a first transport engagement face, that is embodied for transport engagement with a first transporting device, and a second transport engagement face, different from the first, that is embodied for transport engagement with a second transporting device, different from the first.

Especially advantageously, as the conveyor means, so-called double-belt conveyors can be used, which have two conveyor belts spaced apart from one another orthogonally to their conveying direction. Between them, a selectively activatable stop for the workpiece holder can for instance be located. Alternatively, one of the conveyor belts can be replaced by passive conveyor means, such as nondriven conveyor rollers. In that case, the transport engagement face mentioned above is advantageously embodied in multiple parts, so that transport engagement faces can be assigned to each partial conveyor means, such as a conveyor belt or the like.

For the case of conveyor means in two parts, a size of an optionally multi-part transport engagement face oriented to the spacing of the two partial conveyor means, that is, the conveyor belt or passive conveyor means, is called the transportation lane width. For embodying the workpiece holder for transport engagement with different transporting devices, it is advantageous if the first transport engagement face has a first transportation lane width, and the second transport engagement face has a second transportation lane width, different from the first transportation lane width.

The workpiece holder can be brought especially simple into transport engagement with a transporting device if the first transport engagement face and/or the second transport engagement face is a support face pointing in the direction of the action of gravity.

A workpiece holder with an excessively great structural height can be avoided by providing that the first transport engagement face and the second transport engagement face are support faces located in an essentially common plane, and at least one guide device of the group comprising the first guide device and the second guide device has a guide groove, which extends between the first transport engagement face and the second transport engagement face.

Since processing lines, for effective utilization of space, often have angled transport paths, especially with right angles, it is advantageous if the workpiece holder is embodied as essentially square, since in that case its conveying direction can be deflected with a lifting-transverse unit by 90?, without having to pay attention to the orientation of the workpiece holder.

In that case, it is advantageous if an outer peripheral portion of each side of the square workpiece holder has a support face, so that each side of the square workpiece holder can enter into sliding-contact engagement with a corresponding counterpart face of the guide geometry of the processing line. Then, once again, the orientation of the workpiece holder relative to the transporting device is not critical.

In order to remove the workpiece holder from one transport path and place it optionally on another transport path or in a processing nest or the like, it is advantageous if it has at least one engagement recess for engagement with a relocating device. To that end, for reasons of unification, it can advantageously at least one positioning brush, which has the at least one engagement recess. As a result, the bush can be procured at low cost as a mass-produced product that is processed or even already completely processed so that complicated processing of the workpiece holder for forming engagement recesses is unnecessary. Moreover, worn or otherwise defective positioning brushes can thus be easily replaced by intact ones, which makes repair of the workpiece holder considerably easier.

In the case of the advantageous use of square workpiece holders, in the region of each side of the square workpiece holder, at least one engagement recess should preferably be provided.

An advantageous compact workpiece holder can be obtained by providing that the at least one engagement recess is embodied in the region of the first or the second transport engagement face.

In an advantageous refinement of the present invention, the engagement recess, at its pilot pin introduction opening, has an introduction aid, to facilitate introducing pilot pins. To that end, the engagement recess, in the region of its pilot pin introduction opening, can be embodied with increasing diameters counter to the pilot pin introduction direction. For instance, the pilot pin introduction opening can be rounded, looking at a cross section that contains the axis of the engagement recess, and can have a predetermined radius.

For the most flexible possible use in processing lines, the workpiece holder can be embodied such that it has a replaceable wirelessly readable data store, which can be written with workpiece data and/or processing data and/or handling data and/or process flow data. In that case, the data store can be read out at a predetermined processing station, and from the data read out, a workpiece can be recognized, and/or one of a plurality of possible processing sequences can be selected. Moreover, the data store can also be embodied as writable, so that the processing station can write data on it, preferably again in wireless fashion. This can be utilized to increase the quality assurance on the processing line.

In principle, the data store can be an arbitrary data store, such as a barcode, magnetic strip, and the like. Preferably, the data store is an RFID chip, which makes it possible to read out a comparatively large amount of data in wireless and contactless fashion even over distances of several centimeters. An RFID chip can also be writeable.

In principle, it is conceivable that the data store be mounted on the outside of the workpiece holder. For securing the data store against external influences, however, it is advantageous if the workpiece holder is embodied in at least two parts, and one part, preferably a corner region of the workpiece holder, holds the data store.

To avoid unwanted detachment of the data store from the workpiece holder simply because of the transporting motion of the workpiece holder, the part that carries the data store can be removable from the remaining part of the workpiece holder in a direction orthogonal to the guidance direction.

For the sake of greater sturdiness, it is advantageous if the workpiece holder is made essentially of metal. This should not preclude also providing plastic parts on it, for instance for receiving the workpiece. However, the majority of the workpiece holder should be of metal. It is advantageous in this respect especially to use an especially dense metal, such as steel, since then the workpiece holder has an advantageous high mass inertia, so that for instance the aforementioned relocating device can engage the engagement recesses with a rapid motion. Then, because of the increased inertia of the workpiece holder and the resultant forces of inertia that are operative at high acceleration, a separate holding-down device need not be provided for assuring an engagement of the relocating device with the workpiece holder. However, aluminum workpiece holders are also conceivable.

The present invention will be described below in further detail in conjunction with the accompanying drawings.

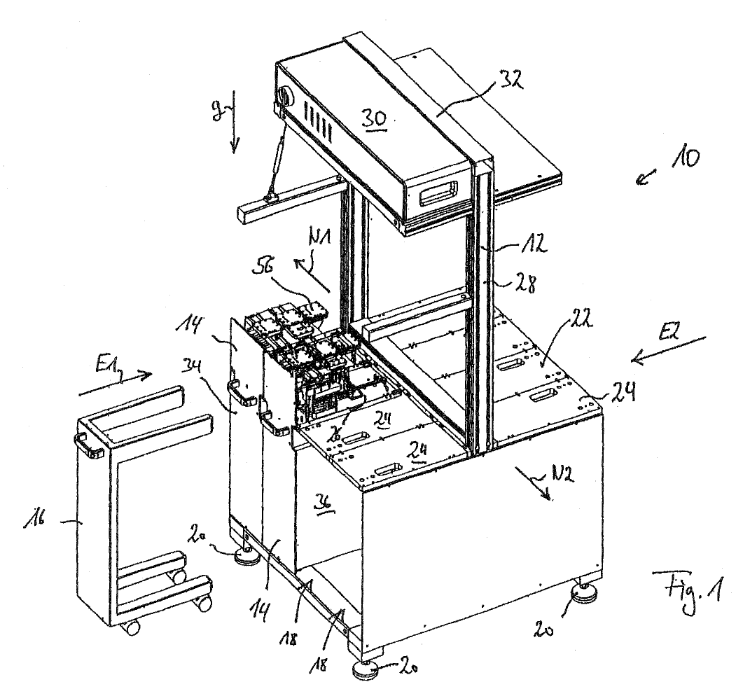

FIG. 1 shows a processing station of a processing line, on which an embodiment according to the invention of a workpiece holder is used;

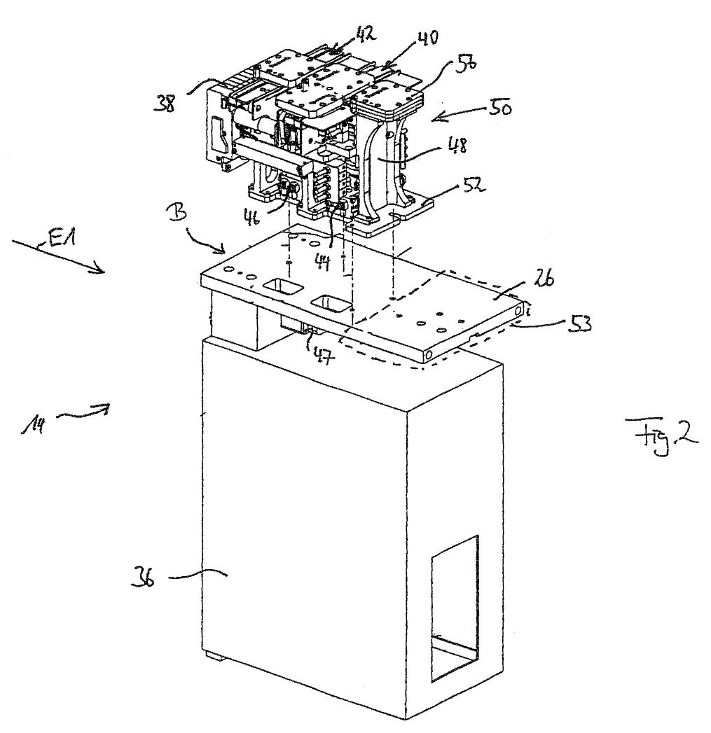

FIG. 2 shows a withdrawable module with transporting devices and a processing nest of the processing station of FIG. 1;

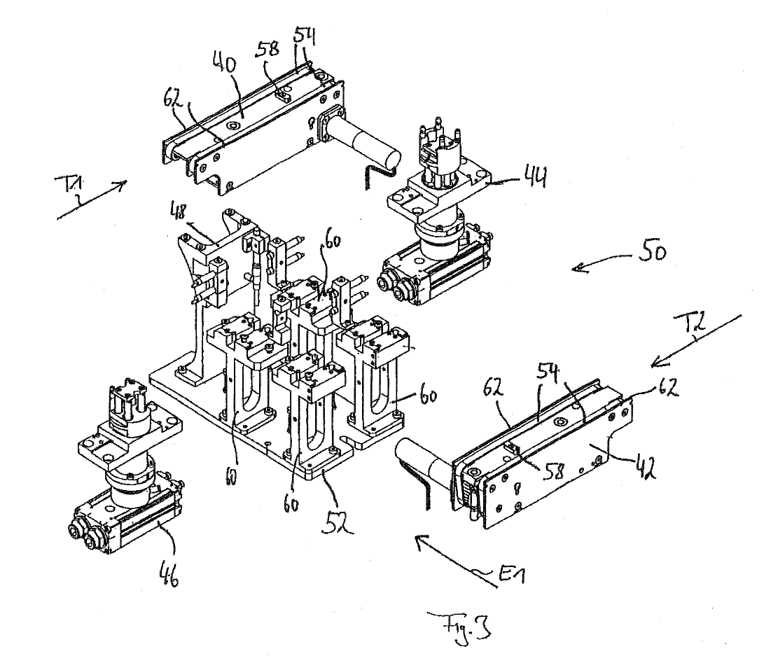

FIG. 3 shows a perspective exploded view of a structural unit comprising a transporting device, workpiece holder relocating devices and a processing nest of the withdrawable module of FIG. 2;

FIG. 4 shows a top view on the unit of FIG. 3;

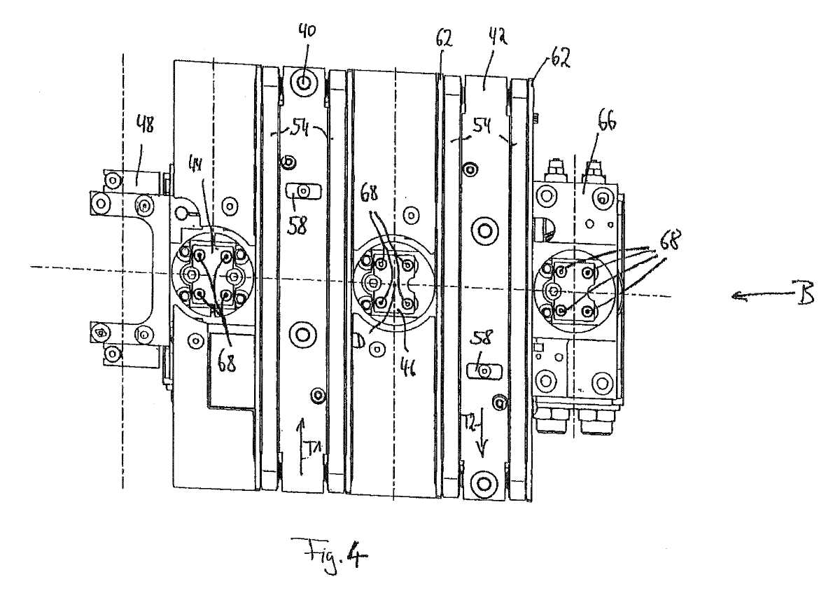

FIG. 5 shows a perspective view of a relocating device which is in engagement with an embodiment according to the invention of a workpiece holder;

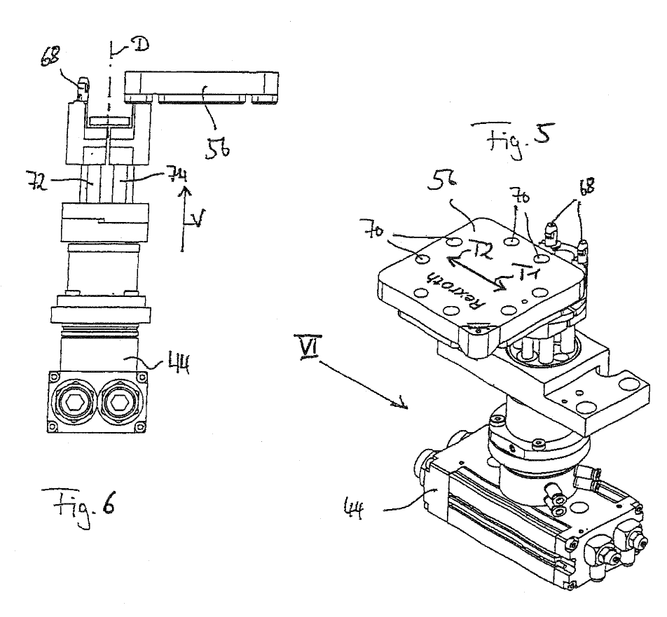

FIG. 6 shows a front view of the relocating device with the workpiece holder of FIG. 5;

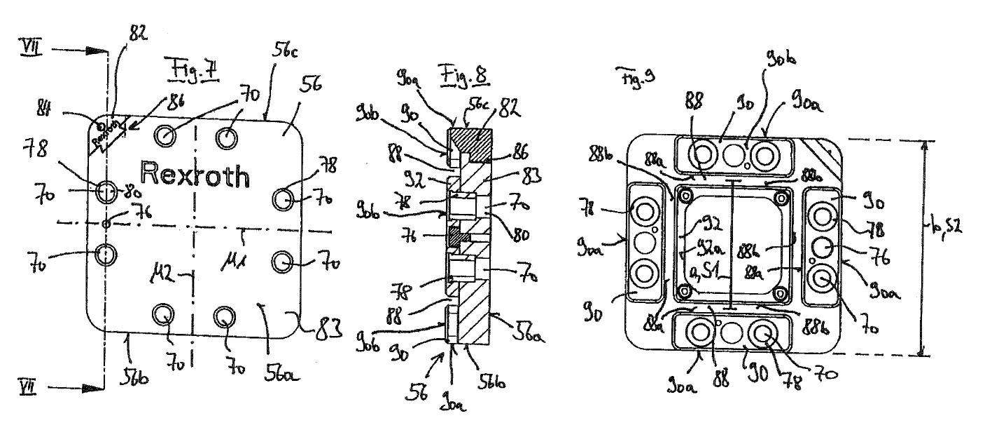

FIG. 7 shows a top view on a workpiece holder of the invention;

FIG. 8 shows a sectional view of the workpiece holder of FIG. 7 along the line VII-VII;

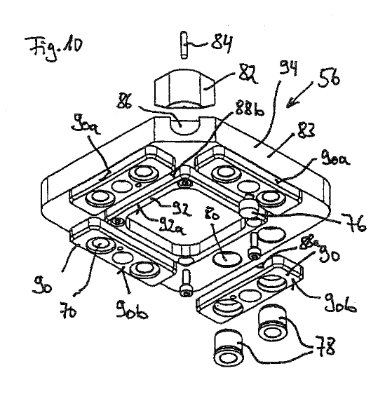

FIG. 9 shows a view of the workpiece holder of FIGS. 7 and 8 from below;

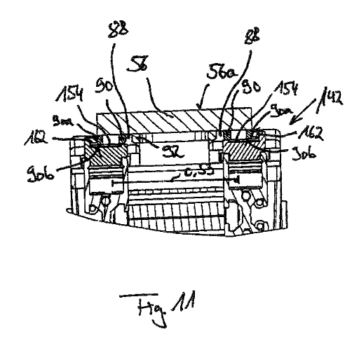

FIG. 10 shows a perspective exploded view of the workpiece holder of FIGS. 7 through 9;

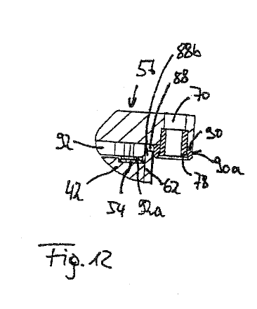

FIG. 11 shows a detailed cross-sectional view of the workpiece holder of FIGS. 7 through 10 on a second transporting device, which is different from those of FIGS. 1 through 4; and

FIG. 12 shows a detailed cross-sectional view corresponding to FIG. 11 of a workpiece holder of FIGS. 7 through 10 on a transporting device of the kind shown in FIGS. 1 through 4.

In FIG. 1, a view according to the invention is shown of a processing station identified in general by reference numeral 10.

The processing station 10, which may be a component of a processing line, not shown, serves to process and handle workpieces, for instance for assembling small equipment, such as power drill gears, and the like. The processing station includes a framework 12, which serves as a module platform, into which withdrawable modules 14 can be inserted in a first insertion direction E1. For that purpose, a withdrawable module 14 is placed with an auxiliary cart 16 in front of the desired module receptacle 18 and is then inserted into the module platform 12 in the first insertion direction E1.

The module platform 12 is constructed such that four withdrawable modules 14 can be inserted side by side in the first insertion direction E1 into the module platform, and four further withdrawable modules on the opposite side of the module platform 12 can be inserted into the module platform in a second insertion direction E2. The insertion directions E1 and E2 are opposed to one another.

The module platform 12 rests on adjustable-feet 20, so that a bottom face 22 of the module platform can be aligned with respect to the direction g of gravity, preferably in such a way that the bottom face 22 is “in the water”.

The bottom face 22 is formed of a total of eight flat base plates 24, all of which together form a common support plane. Each base plate 24 is assigned to one module receptacle 18.

The withdrawable modules 14 include module base plates 26, which rest essentially flatly on the base plate 24 whenever the withdrawable module 14 has been inserted into the module platform 12.

The module platform 12, on an upper framework 28 protruding past the bottom face 22, has a switchbox 30, which includes a control/regulating device, which communicates with the withdrawable modules 14 when they have been inserted into the module platform 12. A cable conduit 32, extending across the width of the module platform 12, is furthermore provided, in which supply and data transmission lines for a processing line can be located.

In the direction of the arrows N1 and N2 next to the processing station 10, further identical or similar processing stations can be provided, for forming a processing line.

In FIG. 2, a perspective exploded view of the withdrawable module 14 is shown; the plate 34 toward the operator (see FIG. 1) has been left out, for the sake of simplicity.

The withdrawable module 14 includes a control housing 36, in which control/regulating units can be received, which can be embodied for controlling processing and/or handling devices, not shown, that can be located on the module base plate 26. The control/regulating units provided in the control housing 36 can also be embodied for triggering a valve island 38, a first transportation path 40, and a second transportation path 42, and for controlling a process relocating device 44 and a transportation path relocating device 46. The control/regulating units can be connected to the switchbox 30 and the control/regulating device provided in it via a hybrid male plug 47, which, whenever the withdrawable module 14 has been inserted into the module platform 12, is inserted into a hybrid female plug, not shown, that is provided on the module platform 12. The valve island 38, the transportation paths 40, 42, and the relocating devices 44, 46 can alternatively, via a male electrical plug, also be connected directly to the control/regulating device in the switchbox 30 without the intermediate placement of a control/regulating unit in the control housing 36.

The hybrid male plug 47 includes a male electrical plug for power cords and data transmission lines and a male pneumatric plug 49, which on insertion of the withdrawable module 14 into the module platform 12 forms a plug connection with a female pneumatric plug, provided in the hybrid female plug of the module platform 12, for carrying compressed air as far as the valve island 38. There, depending on the triggering of the pneumatic switching valves located in the valve island 38, the compressed air can be carried selectively onward.

The valve island 38, the transportation paths 40 and 42, the relocating devices 44 and 46 (see also FIG. 3), and a processing nest 48 are mounted as a preassembled structural unit 50 on the module base plate 26. The preassembled structural unit 50, for that purpose, includes a common structural unit base plate 52, which carries the components of the preassembled structural unit 50.

The preassembled structural unit 50 is mounted on the module base plate 52 in such a way that the valve island 38 is placed closer to the operator side B of the withdrawable module 14. As a result, any oily waste air from the pneumatic switching valves of the valve island 38 can be prevented from reaching processing and/or handling devices that can be located downstream, in terms of the insertion direction E1, from the processing nest 48. For their placement, a processing region 53, indicated by dashed lines, is reserved on the module base plate 26. To facilitate the placement of such processing and/or handling devices, bores and/or holes and/or grooves can be provided in the module base plate 26.

In FIG. 3, the preassembled structural unit 50 is shown in an exploded view. The valve island 38 has been left out of the view in FIG. 3.

The first transportation path 40 and the second transportation path 42 are constructed essentially identically and are formed by a double-belt conveyor device. To that end, the second transportation path 42, which in this description represents the first transportation path 40 as well, includes two parallel belt conveyor belts 54 spaced apart from one another. The second transportation path 42 is provided for moving workpiece holders 56 (see FIG. 1 or FIG. 2) in a second transporting direction T2. Accordingly, the first transportation path 40 is embodied for conveying workpiece holders in the opposite, first transporting direction T1.

The second transportation path 42, like the first transportation path 40, includes a stop 58 that is selectively adjustable between a stop position and an open position, which in the extended state acts as a stop for workpiece holders conveyed on the transportation paths 40 and 42 and in the retracted state is run over by these workpiece holders.

Like the processing nest 48, various individual holders 60 are screwed onto the structural unit base plate 42. The holders 60 serve to receive the transportation paths 40 and 42 and the relocating devices 44 and 46. In an advantageous refinement, not shown, of the present invention, the four individual holders 60 can also be combined into one integral holder arrangement.

By means of the arrangement shown in FIG. 3, the transportation paths 4Q and 42, the relocating devices 44 and 46, and the processing nest 48 can be aligned ideally with one another, before the withdrawable module 14 that holds the structural unit 50 is inserted into a module platform 12.

The relocating device 46 shown in FIG. 3 is a transportation path relocating device, which is embodied for relocating workpiece holders 56 from the first transportation path 40 to the second transportation path 42 and vice versa. To that end, the relocating device 46 lifts the workpiece holder on a transportation path until the workpiece holder 56 becomes disengaged from the guide strips 62 of the transportation paths 40 and 42. Then, the relocating device 46 pivots the workpiece holder 1800 and sets it down between the guide strips 62 of the respective other transportation path. It follows that the transportation paths 40 and 42 are located at a spacing from one another that is determined by the size of the workpiece holder 56, and the axis of rotation of the relocating device 46 is located in the middle, spaced apart by the same distance from each of the transportation paths 40 and 42.

The relocating device 44 is conversely a process relocating device, which is embodied for relocating workpiece holders from the first transportation path 40 to the processing nest 48 and vice versa. As a result, a workpiece holder can be taken from the transportation path and processed at the processing nest 48 by processing and/or handling devices, regardless of transporting operations taking place on the first transportation path.

In FIG. 4, a top view is shown onto the first and second transportation paths 40, 42, the process relocating device 44, the transportation path relocating device 46, and the processing nest 48. A third relocating device 66 is also shown, which is capable of pivoting a workpiece holder, not shown, from the second transportation path 42 to the side pointing away from the processing nest 48, or in other words toward the operator side B. Each of the relocating devices 44, 46, 66 has a total of four pilot pins 68, which engage the workpiece holder in order to relocate it. The pins 68 are essentially identical and are merely located with a different orientation on the various relocating devices.

For relocating a workpiece holder, only two of four pins 68 of one relocating device each engage corresponding recesses 60 (see also FIG. 5) in the workpiece holder 56. Pins 68 spaced apart from one another in the transporting direction T1 and T2 always form such engagement pairs. The axis of rotation of the transportation path relocating device 46 is marked D in FIG. 4. It is orthogonal to the plane of the drawing in FIG. 4. The axis of rotation D has the same spacing from the first transportation path 40 as from the second transportation path 42. A workpiece holder moved by the transportation paths 40 and 42 must be at least wide enough that the pairs of pins 68 located closer to the particular transportation path on which the workpiece holder is being moved are capable of engaging the workpiece holder. In order that the workpiece holder 56 can be grasped selectively both by the transportation path relocating device 46 and by the process relocating device 44 or the third relocating device 46 (depending on which transportation path it is located on), the workpiece holder preferably protrudes to both sides of the transportation paths 40 and 42 past the transportation paths by a suitable amount.

With the transportation path relocating device 46 located in the middle between the first and second transportation paths 40 and 42, the process relocating device 44 is located in the middle of the spacing between the processing nest 48 and the first transportation path 40.

So that the orientation of a workpiece holder 56 on the transportation paths 40, 42 will not be critical, preferably essentially symmetrical workpiece holders 56 with a square outline will be used, which have recesses 70 on each side for engagement by the pins 68.

It will be noted that the axes of rotation D of all the relocating devices 44, 46 and 66 in FIG. 4 all have the same spacing from the respective closest associated transportation path.

In FIG. 5, the process relocating device 44 is shown in perspective. The process relocating device 44 in FIG. 5 is in engagement with the workpiece holder 56 having the substantially square outline. The recesses 70 for engagement by the pins 68 of the process relocating device 44 can be seen.

In FIG. 6, a front view in the direction of the arrow VI in FIG. 5 is shown of the process relocating device 44.

The relocating devices 44, 46 and 66 used in the example shown are so-called lifting-rotating units, which after grasping a workpiece holder 56 lift it in the direction of the arrow V along its axis of rotation D and pivot it by 180° about this axis of rotation D. For lifting workpiece holders 56, the process relocating device 44 has two lifting systems 72 and 74, actuatable separately from one another, which assures that a workpiece holder received in the processing nest 48 can be grasped and lifted by one of the lifting devices 72 or 74, without the other lifting device being raised as well and thus protruding into the path of motion of a workpiece holder that is moving along the first transportation path 40. This assures that the transporting function of the transportation path 40 is preserved, regardless of whether a workpiece holder is located in the processing nest 48 or not. As a result, workpiece holders from the transportation path 40 can pass a workpiece holder received in the processing nest 48.

In FIG. 7, the workpiece holder 56 is shown in a top view. The workpiece holder 56 is essentially square with rounded corners. The rounding of the corners serves to shorten the pivoting radius upon pivoting of the workpiece holder by a relocating device about the about the pivot axis D.

In FIG. 7, the view is to the workpiece receiving face 56a of the workpiece holder 56. This workpiece receiving face 56a can be provided with a device for receiving a workpiece in a specified position and/or orientation.

The workpiece holder 56 has a total of eight engagement recesses 70 for engagement with the pilot pin 68. These engagement recesses 70 are provided in pairs on each of the four sides, symmetrically to the two center axes M1 and M2, orthogonal to one another, of the workpiece holder 56.

Between the engagement recesses 70 on the left in FIG. 7 is a recognition element 76, which is detected by proximity switches that are located in the vicinity of the respective side of the workpiece holder. Such recognition elements 76 can also be provided between the other pairs of engagement recesses 70.

Each engagement recess 70 includes one positioning brush 78, which is inserted into a bore 80 of the workpiece holder 56.

The workpiece holder 56 furthermore has a part 82, which is removable from it and in which an RFID chip 84 is received, as a data store that can read out in wireless fashion. The removable part 82 can be introduced along a dovetail guide 86 from the remaining body 83 of the workpiece holder 56 and removed from it. The introduction direction is orthogonal to the plane of the drawing in FIG. 7 and thus orthogonal to any possible transporting direction of the workpiece holder 56.

In FIG. 8, the workpiece holder 56 is shown in section along the line VII-VII of FIG. 7. Guide grooves 88 can be seen, which extend parallel both to one another and to the parallel sides 56b and 56c. Each guide groove 88 has support faces 88a and 88b, pointing toward one another, which are embodied for engagement with corresponding counterpart support faces of the guide rails 62 of the transport paths 40 and 42 (see FIG. 4). These guide grooves are formed by identical peripheral support elements 90 and one central support element 92, which are provided on the face of the workpiece holder 56 opposite the workpiece receiving face 56a. Each lateral boundary face of the central support element 92 includes one support face 88b, and every lateral boundary face, pointing toward the central support element 92, of the peripheral support elements 90 includes one further support face 88a. The guide grooves 88 and the support faces 88a and 88b forming them form a first guide device as defined in the present application.

The side faces of the peripheral support elements 90 opposed to the support faces 88a and pointing away from the central support element 92 furthermore each include one external guide support face 90a. These external guide support faces 90a form a second guide device as defined in the present invention; the spacing a between the transverse centers of two pairs of parallel guide grooves 88 defines a first lane width S1, and the spacing b between two pairs of parallel external guide support faces 90a defines a second lane width S2.

Although in the view in FIGS. 8 and 9 the support faces 88a, 88b and 90a are shown embodied parallel to one another, this is not absolutely necessary. The support faces 88a, 88b and 90a that each extend along a common guidance direction can also be inclined toward one another about an axis of inclination extending in the guidance direction.

The support face 92a (see FIG. 9) of the central support element 92 that points away relative to the workpiece receiving face 56a forms a transport engagement face for engagement with the belts 54 of the transport paths 40 and 42. In contrast, the support faces 90b of the peripheral support elements 90 form transport engagement faces for supporting engagement with a further transport path, which is shown in FIG. 11.

In FIG. 10, a perspective exploded view of the workpiece holder 56 is shown, obliquely from below. It can be seen that the central support element 92 is screwed onto a workpiece holder base plate 94. The peripheral support elements 90 are conversely glued to the workpiece holder base plate 94. Alternatively or in addition, they may also be screwed to the workpiece holder base plate 94.

Both the workpiece holder base plate 94 and all the support elements 90 and 92 are preferably made from steel, to lend the workpiece holder 56 as large an inertial mass as possible. In that case, the pilot pins 68 of the relocating devices 44 and 46 can then move into the engagement recesses 70 at high speed, without requiring that a physical holding-down device counteracting the introduction forces has to be provided, since the dynamic forces that occur upon a rapid introduction motion of the pilot pins 86 on the large-mass workpiece holder 56 act like holding-down forces.

The removable workpiece holder part 82 that receives the data store 84 (RFID chip) can likewise be made from steel, some other metal, or even plastic. To assure a defined position of the workpiece holder part 82 relative to the remainder 83 of the workpiece holder, the dovetail guide 86 does not pass through the workpiece holder base plate 94. Instead, an end stop is formed there in the direction in which the workpiece holder part 82 that holds the RFID chip 84 is thrust on.

In FIG. 11, a transport path 142 that differs from the transport paths 40 and 42 is shown, which transports a workpiece holder 56 of the kind that has been described in conjunction with FIGS. 7 through 10.

The support faces 90b of two peripheral support elements 90 extending parallel to one another rest on conveyor belts 154 that are spaced apart from one another. The workpiece holder 56 is entrained by the conveyor belts 154 by friction-locking engagement.

The workpiece holder 56 is guided by external guidance along the transporting direction that is orthogonal to the plane of the drawing in FIG. 11, and it can be seen that the external guide support face 90a is in sliding support engagement with counterpart support engagement faces pointing toward one another on guide strips 162.

It should be noted that the spacing c between the transverse centers of the support faces 90b of the peripheral support elements 90 that are jointly in transporting engagement defines the transportation lane width S3 of the workpiece holder 56 for the transport path 142.

Conversely, in FIG. 12, the situation in which the workpiece holder 56 is supported and in transport engagement with the transport path 42 is shown. Here, the support face 92a of the central support element 92 rests on the conveyor belts 54. Once again, the workpiece holder 56 is entrained by friction locking between each conveyor belt 54 and the support face 92a, in a transporting direction that is orthogonal to the plane of the drawing in FIG. 12.

For guiding the workpiece holder 56, the side of the guide strips 62, protruding past the conveyor belts 54 toward the workpiece holder 56, protrudes into a guide groove 88 of the workpiece holder 56. In the present case, the support face 88b of the central support element 92 rests slidingly on a counterpart support face, pointing toward the conveyor belts 54, of the guide strip 62. However, as seen in FIG. 4, the transport path 42 has two guide strips 62 parallel to one another, and the lane width S1 associated with the transport path 42 is slightly greater than the spacing of the transverse centers of the parallel guide strips 62 orthogonally to the transporting direction. Moreover, each guide groove 88 is slightly wider than the width of the guide strips 62. By means of these provisions, manufacturing variations in the workpiece holder 56 and in the transport paths 40, 42 are well compensated for, without a sacrifice in terms of guidance precision.

Alternatively, the lane width S1 may also be slightly smaller than the spacing, measured in the same direction, of the guide strips 62. Then, in contrast to what is shown in FIG. 12, essentially the support face 88a embodied on the peripheral support elements 90, in cooperation with a counterpart support face, pointing away from the conveyor belts 54, of the guide strip 62 contributes to guiding the workpiece holder 56 in the transporting direction.

1. A workpiece holder for transporting workpieces in flexible processing lines, in particular assembly lines, which is embodied for guidance along a guidance direction (T1, T2) by means of a guide geometry (62, 162) of the processing line extending in the guidance direction, and the workpiece holder (56) has a first guide device (88, 88a, 88b) for guide engagement with a first guide geometry (62) extending in the guidance direction,
characterized in that the workpiece holder (56) has a second guide device (90a), embodied separately from the first guide device (88, 88a, 88b), which second guide device is embodied for guide engagement with a second guide geometry (162), different from the first guide geometry (62) and extending in the guidance direction.

2. The workpiece holder as defined by claim 1,
characterized in that at least one guide device (88, 88a, 88b; 90a), and advantageously both guide devices, have a support face (88a, 88b, 90a) extending in the guidance direction (T1, T2), which face is associated with a guide geometry (62, 162) and embodied for sliding contact with a counterpart support face thereof.

3. The workpiece holder as defined by claim 1,
characterized in that the at least one guide device (88, 88a, 88b; 90a), and advantageously both guide devices, have two support faces (88a, 88b; 90a) extending essentially in opposite directions in the guidance direction (T1, T2), of which each support face is embodied for sliding contact with a respective counterpart support face of a guide geometry (62, 162).

4. The workpiece holder as defined by claim 3,
characterized in that the first guide device (88, 88a, 88b) has a first guide lane width (S1), and the second guide device (90a) has a second guide lane width (S2) that is different from the first guide lane width (S1).

5. The workpiece holder as defined by claim 2,
characterized in that at least one guide device (88, 88a, 88b) has at least one guide groove (88) extending in the guidance direction (T1, T2).

6. The workpiece holder as defined by claim 2,
characterized in that at least one guide device (88, 88a, 88b) has at least one guide rail extending in the guidance direction (T1, T2).

7. The workpiece holder as defined by claim 2,
characterized in that an outer peripheral portion of the workpiece holder (56) has the support face (90a).

8. The workpiece holder as defined by claim 2,
characterized in that it has support faces (88a, 88b; 90a) and/or guide grooves (88) and/or guide rails, in each case orthogonal to one another, and preferably pairs of support faces (88a, 88b; 90a) and/or pairs of guide grooves (88) and/or pairs of guide rails that are all orthogonal to one another.

9. The workpiece holder as defined by claim 8,
characterized in that one guide device (88, 88a, 88b) has a guide groove (88) or a guide rail, and the other guide device (90a) has an outer peripheral portion, embodied as a support face (90a), of the workpiece holder (56).

10. The workpiece holder as defined by claim 1,
characterized in that it has a first transport engagement face (92a), which is embodied for transport engagement with a first transporting device (40, 42); and that it has a second transport engagement face (90a), different from the first, that is embodied for transport engagement with a second transporting device (142), different from the first (40, 42); and preferably the first transport engagement face (92a) has a first transportation lane width, and the second transport engagement face (90b) has a second transportation lane width (S3), different from the first transportation lane width.

11. The workpiece holder as defined by claim 10,
characterized in that the first transport engagement face (92a) and/or the second transport engagement face (90b) is a support face pointing in the direction of the action of gravity.

12. The workpiece holder as defined by claim 10,
characterized in that the first transport engagement face (92a) and the second transport engagement face (90b) are support faces located in an essentially common plane, and one guide device of the group comprising the first guide device (88, 88a, 88b) and the second guide device (90a) has a guide groove (88), which extends between the first transport engagement face (92a) and the second transport engagement face (90b).

13. The workpiece holder as defined by claim 1,
characterized in that it is essentially square.

14. The workpiece holder as defined by claim 13,
characterized in that an outer peripheral portion of each side of the square workpiece holder (56) has a support face (90a).

15. The workpiece holder as defined by claim 1,
characterized in that it has at least one engagement recess (70) for engagement with a relocating device (44, 46, 66).

16. The workpiece holder as defined by claim 15,
characterized in that it has at least one positioning brush (78), which has the at least one engagement recess (70).

17. The workpiece holder as defined by claim 15
characterized in that in the region of each side of the square workpiece holder (56), at least one engagement recess (70) is provided.

18. The workpiece holder as defined by claim 15,
characterized in that the at least one engagement recess (70) is embodied in the region of the first or the second transport engagement face (90b).

19. The workpiece holder as defined by claim 1,
characterized in that it has a replaceable wirelessly readable data store (84), which can be written with workpiece data and/or processing data and/or handling data and/or process flow data.

20. The workpiece holder as defined by claim 19,
characterized in that the data store (84) has an RFID chip.

21. The workpiece holder as defined by claim 19,
characterized in that the workpiece holder (56) is in at least parts, and one part (82), preferably a corner region of the workpiece holder (56), holds the data store (84).

22. The workpiece holder as defined by claim 21,
characterized in that the part (82) that carries the data store (84) is removable from the remaining part (83) of the workpiece holder in a direction orthogonal to the guidance direction (T1, T2).

23. The workpiece holder as defined by claim 1,
characterized in that it is essentially of metal, in particular of steel or aluminum.
